(19) United States
(12) Patent Application Publication
(10) Pub. No.: US 2026/0332245 A1
(43) Pub. Date: Oct. 22, 2026

(54) SATELLITE CONSTELLATION AND METHOD OF ESTABLISHING INTER-SATELLITE LINKS

(71) Applicant: European Space Agency, Paris (FR)

(72) Inventor: Francisco Amarillo Fernandez, Noordwijk (NL)

(21) Appl. No.: 19/114,864

(22) PCT Filed: Sep. 26, 2022
(86) PCT No.: PCT/EP2022/076711

§ 371 Date: Mar. 25, 2025

(51) Int. Cl. H04B 7/185; B64G 1/10; B64G 1/24

(52) U.S. Cl. CPC H04B 7/18521; B64G 1/1085; B64G 1/242; H04B 7/18534

(57) ABSTRACT

A method of establishing inter-satellite links (ISLs) between a constellation of satellites in which the satellites are arranged in a plurality of orbital planes, in pairs with substantially diametral orbit positions, includes, for a given satellite: in a first time period, establishing ISLs between the satellite and a first set of satellites including one or more pairs of satellites in a first orbital plane; in a second time period, establishing ISLs between the satellite and a second set of satellites including one or more pairs of satellites in a second orbital plane; and in a third time period, establishing ISLs between the satellite and a third set of satellites including one or more pairs of satellites in a third orbital plane. The first to third orbital planes are different from each other. The application further relates to a constellation of satellites.

### BACKGROUND

### Technical Field

This application relates to inter-satellite link (ISL) connectivity. In particular, the application relates to constellations of satellites and to methods of establishing ISLs between satellites of a constellation of satellites.

### Description of the Related Art

There is a need for improved techniques and schemes for inter-satellite link connectivity for constellations of satellites including, for example, Galileo Next Generation (G2G). There is further need for improved techniques and schemes for orbit and clock determination for satellites of a constellation of satellites.

### BRIEF SUMMARY

In view of this need, the present disclosure proposes a method of establishing inter-satellite links between satellites of a constellation of satellites as well as a constellation of satellites, having the features of the respective independent claims.

An aspect of the disclosure relates to a method of establishing inter-satellite links (ISLs) between satellites of a constellation of satellites. The satellites may be arranged in a plurality of orbital planes in pairs of satellites orbiting Earth in substantially diametral orbit positions. The method may include, for a given satellite among the constellation of satellites, in a first period of time, establishing inter-satellite links between the given satellite and a first set of satellites including one or more pairs of satellites in a first orbital plane among the plurality of orbital planes. The method may further include, for the given satellite, in a second period of time, establishing inter-satellite links between the given satellite and a second set of satellites including one or more pairs of satellites in a second orbital plane among the plurality of orbital planes. The second orbital plane may be different from the first orbital plane. The method may yet further include, for the given satellite, in a third period of time, establishing inter-satellite links between the given satellite and a third set of satellites including one or more pairs of satellites in a third orbital plane among the plurality of orbital planes. The third orbital plane may be different from the first and second orbital planes. Here and in the following, it is understood that establishing the inter-satellite links may be subject to a line of sight existing between the satellites involved. Specifically, establishing the inter-satellite links may be subject to visibility of the satellites from one another (e.g., subject to the absence of (mutual) eclipses) and, needless to say, that the given satellite does not coincide with the respective satellite in the one of the first to third orbits. The time periods may be consecutive time periods. For example, the second time period may immediately follow the first time period and the third time period may immediately follow the second time period.

Establishing ISLs in this manner, using relationships between orbital plane orientation and satellite arrangement within orbital planes, allows to obtain ranging information particularly suitable for accurately determining a position of the given satellite, relative to the other satellites of the constellation. This can be achieved by exploiting geometric relationships among respective satellite positions in each time period. By the same token, accurate clock determination is enabled using the ISLs established according to the proposed method.

In some embodiments, each of the first to third sets of satellites may include two pairs of satellites. Further, in each of the first to third sets of satellites, neighboring satellites, along orbit, may be shifted from each other along orbit by 90° in argument of latitude angle. For instance, each set may comprise two pairs of satellites, which would then be located, along orbit, at 0°, 90°, 180°, and 270° argument of latitude angle.

In some embodiments, the first to third sets of satellites may include equal numbers of pairs of satellites.

In some embodiments, the method may further include, in a fourth period of time, establishing inter-satellite links between the given satellite and a fourth set of satellites including one or more pairs of satellites in the first orbital plane. Therein, the first and fourth sets of satellites may be disjoint sets. The method may further include, in a fifth period of time, establishing inter-satellite links between the given satellite and a fifth set of satellites including one or more pairs of satellites in the second orbital plane. Therein, the second and fifth sets of satellites may be disjoint sets. The method may yet further include, in a sixth period of time, establishing inter-satellite links between the given satellite and a sixth set of satellites including one or more pairs of satellites in the third orbital plane. Therein, the third and sixth sets of satellites may be disjoint sets. Also here, the time periods may be consecutive time periods.

By establishing additional ISLs in the fourth to sixth periods of time, redundancy (and correspondingly, accuracy) of position and clock determination can be improved.

In some embodiments, each of the fourth to sixth sets of satellites may include two pairs of satellites. In each of the fourth to sixth sets of satellites, neighboring satellites, along orbit, may be shifted from each other along orbit by 90° in argument of latitude angle.

In some embodiments, the first to sixth sets of satellites may include equal numbers of pairs of satellites. For instance, each set may comprise two pairs of satellites. This would result in a constellation of 24 satellites in total. Then, each orbital plane would include eight satellites that are shifted from each other by 45° argument of latitude angle.

Accordingly, the proposed method is particularly applicable for the Galileo constellation or the Galileo Next Generation constellation.

In some embodiments, the first to third periods of time may be subdivided into sequential time slots of equal duration. This subdivision may be done in such manner that the first period of time includes a respective time slot for each of the satellites of the first set of satellites, the second period of time includes a respective time slot for each of the satellites of the second set of satellites, and the third period of time includes a respective time slot for each of the satellites of the third set of satellites. Then, the method may include, in the time slots of the first period of time, establishing inter-satellite links between the given satellite and respective satellites of the first set of satellites. The method may further include, in the time slots of the second period of time, establishing inter-satellite links between the given satellite and respective satellites of the second set of satellites. The method may yet further include, in the time slots of the third period of time, establishing inter-satellite links between the given satellite and respective satellites of the third set of satellites.

Thereby, the envisaged sequence of ISLs can be established in an efficient and predictable manner, allowing to integrate the satellites into a connectivity scheme in which each satellite establishes ISLs with all remaining satellites of the constellation (apart from satellites that are under permanent mutual eclipse with the given satellite).

In some embodiments, the fourth to sixth periods of time may be subdivided into sequential time slots of equal duration, in such manner that the fourth period of time includes a respective time slot for each of the satellites of the fourth set of satellites, the fifth period of time includes a respective time slot for each of the satellites of the fifth set of satellites, and the sixth period of time includes a respective time slot for each of the satellites of the fifth set of satellites. Then, the method may further include, in the time slots of the fourth period of time, establishing inter-satellite links between the given satellite and respective satellites of the fourth set of satellites. The method may further include, in the time slots of the fifth period of time, establishing inter-satellite links between the given satellite and respective satellites of the fifth set of satellites. And the method may yet further include, in the time slots of the sixth period of time, establishing inter-satellite links between the given satellite and respective satellites of the sixth set of satellites.

Thereby, the envisaged sequence of ISLs among the full constellation can be established in an efficient and predictable manner, allowing to integrate the satellites into a connectivity scheme in which each satellite established ISLs with the remaining satellites of the constellation (apart from satellites that are under permanent mutual eclipse with the given satellite).

In some embodiments, assuming that the satellites of the constellation of satellites have consecutive numbers assigned thereto, ranging from 1 to N, starting with the satellites of the first set of satellites and followed, in this order, by the satellites of the second to sixth sets of satellites, where N is the number of satellites in the constellation of satellites, and wherein the method proceeds in cycles of N consecutive time slots each, the method may include, in an n-th time slot of the N time slots, establishing inter-satellite links between an s-th satellite and an (n−s)-th satellite, where s runs from 1 to N and wherein numbers of satellites are modulo N. Here, the time-slot index n can take values from 1 to N. Index s is a running index that may be run through for each time slot, i.e., it is understood that multiple inter-satellite links may be established per time slot. In other words, inter-satellite links may be established for all s in {1, . . . , N}. It is also noted that the above may include double-counts for some index values of n, i.e., a pair of satellites (i, j) may also appear as (j, i) in the aforementioned inter-satellite links, for example.

Thereby, a full connectivity scheme among all satellites of the constellation can be established. This connectivity scheme ensures ISLs for all pairs of satellites among the constellation, in a minimum number of time slots (i.e., at minimum cycle duration).

In some embodiments, the inter-satellite links established in each time slot of the cycles may use a first frequency or frequency band. Then, the method may further include, in the n-th time slot of a cycle of N time slots, establishing inter-satellite links between an(s)-th satellite and an (n−s+q)-th satellite using a second frequency or frequency band different from the first frequency or frequency band. Here, s may run from 1 to N, q may be a prime number in the range from 1 to N and not a divisor of N, and the numbers of satellites may be modulo N. Thereby, the method may establish a ring topology of inter-satellite links between the satellites of the constellation of satellites. This ring topology may allow for information propagation among all the satellites of the constellation in each cycle.

In some embodiments, the method may further include, for each time slot, if a combination of an i-th satellite and a j-th satellite for which establishing an inter-satellite link is foreseen in the given time slot is under mutual eclipse, and if the i-th satellite and the j-th satellite are in the same orbital plane, instead of establishing an inter-satellite link between the i-th satellite and the j-th satellite, and further, instead of establishing an inter-satellite link between an (i+Δ)-th satellite and a (j+Δ)-th satellite, establishing an inter-satellite link between the (i+Δ)-th satellite and the i-th satellite, and between the (j+Δ)-th satellite and the j-th satellite, or establishing an inter-satellite link between the (i+Δ)-th satellite and the j-th satellite, and between the (j+Δ)-th satellite and the i-th satellite. Therein, those connections may be adopted or selected that reverse the direction of the data flow for a subset of arcs. Mutual eclipse in this context may mean that there is no line of sight between the satellites involved. Parameter Δ may be defined as Δ=N/2, where N is the number of satellites of the constellation of satellites. It may further be assumed that the time slots have equal duration.

Thereby, the aforementioned ring topology resulting from establishing inter-satellite links in two distinct frequency bands according to a predefined scheme can be achieved or maintained even if two or more of the satellites of the constellation in the same orbital plane are under mutual eclipse.

In some embodiments, the method may further include, for each time slot, if a combination of an i-th satellite and a j-th satellite for which establishing an inter-satellite link is foreseen in the given time slot is under mutual eclipse, and if the i-th satellite and the j-th satellite are not in the same orbital plane, instead of establishing an inter-satellite link between the i-th satellite and the j-th satellite, and further, instead of establishing an inter-satellite link between an (i+Δ)-th satellite and a (j+Δ)-th satellite, establishing an inter-satellite link between the (i+Δ)-th satellite and the i-th satellite, and between the (j+Δ)-th satellite and the j-th satellite, or establishing an inter-satellite link between the (i+Δ)-th satellite and the j-th satellite, and between the (j+Δ)-th satellite and the i-th satellite. Therein, those connections may be adopted or selected that reverse the direction of the data flow for a subset of arcs.

Thereby, the aforementioned ring topology resulting from establishing inter-satellite links in two distinct frequency bands according to a predefined scheme can be achieved or maintained even if two or more of the satellites of the constellation in different orbital planes are under mutual eclipse.

In some embodiments, the method may further include determining ranging information relating to relative distances between the given satellite and respective other satellites of the constellation of satellites based on the established inter-satellite links. The method may yet further include determining an estimate of a position of the given satellite relative to the other satellites of the constellation of satellites based on the determined ranging information. The estimate of the position may be based on a collection/aggregate of the ranging information/measurements. In general, ranging information may be determined based on any established inter-satellite link and the collected/accumulated ranging information may be used for estimating relative positions of the satellites in the constellation of satellites.

In some embodiments, the satellites of the constellation of satellites may be arranged in three orbital planes. Additionally or alternatively, the orbital planes may be substantially orthogonal to each other. That is, the orbital planes may be (substantially) orthonormal planes. For example, an angle between orbital planes may be 90°±3° in some implementations.

Another aspect of the disclosure relates to a constellation of satellites implementing the method according to the preceding aspect or any of its embodiments.

Another aspect of the disclosure relates to a satellite configured to perform (at least part of) the method according to the first-mentioned aspect or any of its embodiments. The satellite may include at least one antenna, transmission/reception circuitry coupled to the at least one antenna, and a control unit (e.g., computer processor) for controlling the antenna and the transmission/reception circuitry.

Another aspect of the disclosure relates to a computer program stored on a non-transitory computer-readable medium comprising instructions that when executed by a control unit of a satellite, cause the satellite to perform (at least part of) the method according to the first-mentioned aspect or any of its embodiments.

It will be appreciated that method steps and apparatus or system features may be interchanged in many ways. In particular, the details of the disclosed method can be implemented by an apparatus or system, and vice versa, as the skilled person will appreciate. Moreover, any of the above statements made with respect to methods are understood to likewise apply to apparatus and systems, and vice versa.

### BRIEF DESCRIPTION OF THE SEVERAL VIEWS OF THE DRAWINGS

Example embodiments of the disclosure are explained below with reference to the accompanying drawings, wherein:

FIG. 1A and FIG. 1B schematically illustrate the concept of orthonormal points relative to Earth;

FIG. 2 schematically illustrates an example of (quasi-) orthogonal orbital planes;

FIG. 3 schematically illustrates an example of three (quasi-) orthogonal orbital planes;

FIG. 4 is a table illustrating an example of an ISL connection scheme between a given satellite and six different sets of satellites among a constellation of satellites, according to embodiments of the disclosure;

FIG. 5 is another table illustrating an example of an ISL connection scheme between six different sets of satellites among a constellation of satellites, according to embodiments of the disclosure;

FIG. 6 to FIG. 11 are flowcharts illustrating examples of a method of establishing ISLs among a constellation of satellites, according to embodiments of the disclosure;

FIG. 12 is a diagram illustrating an example of orbit determination accuracy for a constellation of satellites;

FIG. 13 schematically illustrates an example of a technique for handling in-plane mutual eclipses among the constellation of satellites, according to embodiments of the disclosure;

FIG. 14 is a flowchart illustrating an example of a method of handling in-plane mutual eclipses among the constellation of satellites, according to embodiments of the disclosure;

FIG. 15, FIG. 16A, and FIG. 16B schematically illustrate examples of ISL connection arcs in the method of FIG. 14, according to embodiments of the disclosure;

FIG. 17A and FIG. 17B schematically illustrate an example of a technique for handling inter-plane mutual eclipses among the constellation of satellites, according to embodiments of the disclosure;

FIG. 18 is a flowchart illustrating an example of a method of handling inter-plane mutual eclipses among the constellation of satellites, according to embodiments of the disclosure;

FIG. 19A and FIG. 19B schematically illustrate examples of ISL connection arcs in the method of FIG. 18, according to embodiments of the disclosure; and

FIG. 20 to FIG. 23 schematically illustrate examples of ISL ring topologies among the constellation of satellites, according to embodiments of the disclosure.

### DETAILED DESCRIPTION

In the following, example embodiments of the disclosure will be described with reference to the appended figures. Identical elements in the figures may be indicated by identical reference numbers, and repeated description thereof may be omitted.

The present disclosure relates to advancements and concepts potentially applicable to G2G satellites, for example, and in particular to inter-satellite link connectivity as well as orbit and clock determination schemes.

The ISL connectivity scheme presented in the disclosure is optimized for example to ensure that any single-link payload provides substantial information at ranging measurement-level on the hosting platform:
Orbit along, across, and radial-track position deviations.
On-board clocks deviation (relative to an ensemble clock).
Ranging biases deviations (relative to an ensemble reference).

To this end, embodiments of the disclosure rely on the concepts of orthonormal points on a sphere and quasi-orthogonality amongst Galileo orbital planes.

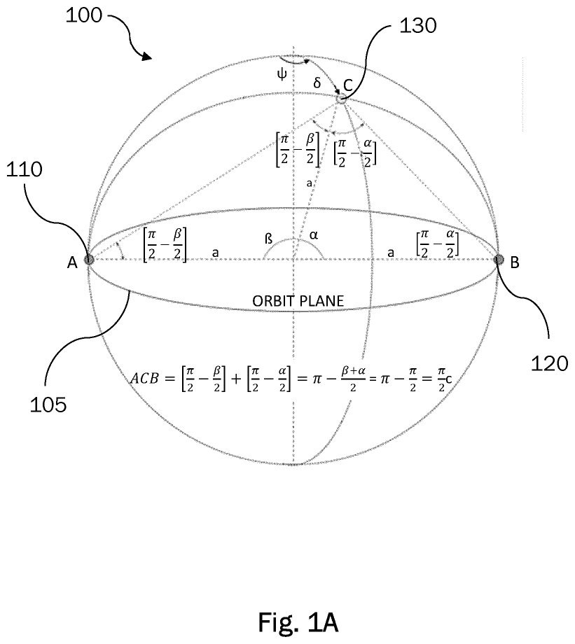

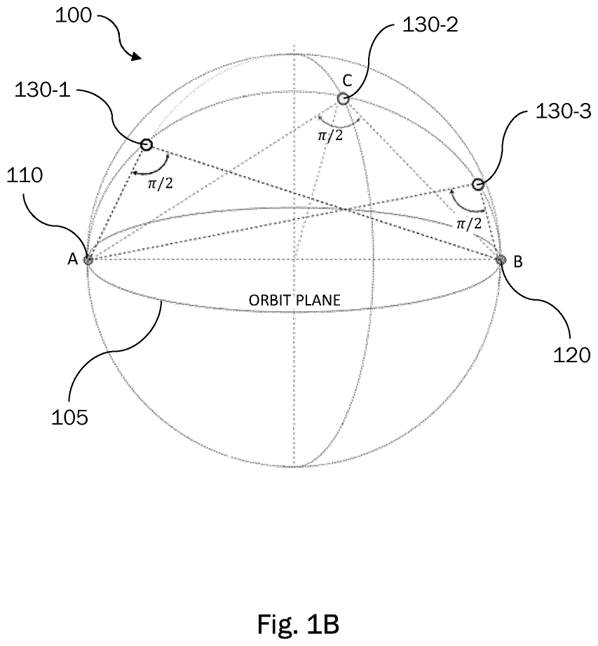

The concept of orthonormal-points on a sphere is schematically illustrated in FIG. 1A and FIG. 1B. As shown therein, point A, 110 and point B, 120 are defined as orthonormal-points if for all other points C, 130 on the sphere 100, the condition AC⊥BC holds. Thus points on diametral opposition in an orbit plane 105, for example, are orthonormal. In the Galileo (GALILEO) constellation, for any orbit plane, and at any time, the theoretical satellite positions correspond to four pairs of orthonormal points.

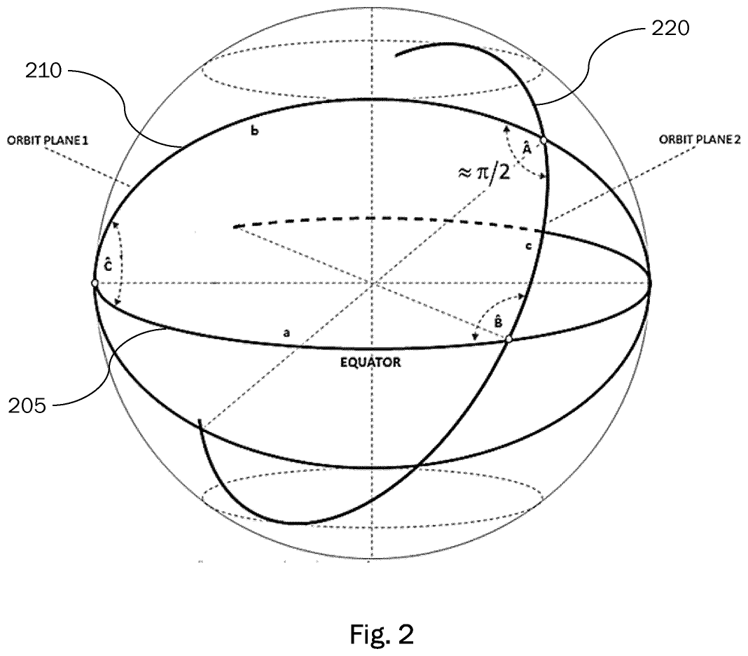

The concept of quasi-orthogonality amongst Galileo orbital planes 210, 220 is schematically illustrated in FIG. 2. Applying the spherical law of cosines for angles Â, \hat{B}, Ĉ and a, to the spherical triangle ABC yields

cos Â=−cos \hat{B}·cos Ĉ+sin \hat{B}·sin Ĉ·cos a [Eq. 1]

In one numerical example, which may be applicable to the Galileo constellation,
Ĉ=56°, orbit plane 1 inclination relative to the equator 205,
\hat{B}=180°-56°=124°, orbit plane 2 co-inclination relative to the equator 205,
a=±120°, Right Ascension of the Ascending Node (RAAN) increment between orbital planes 1 and 2, and orbital planes 1 and 3,
   and the spherical law of cosines of Eq. 1 will yield Â=91.77°≈90°.

In order to facilitate the connectivity discussion, perfect inter-plane orthogonality is assumed. This assumption shall be without intended limitation and it is understood that embodiments of the disclosure also apply to orbital planes with inter-plane angles in the vicinity of 90°, for example 90°±3°.

Accordingly, the present disclosure may assume a constellation of satellites for which the satellites are arranged in a plurality of orbital planes, in pairs of satellites orbiting Earth in substantially diametral (i.e., orthonormal) orbit positions. For example (as is the case for Galileo), the satellites of the constellation of satellites may be arranged in three orbital planes. These orbital planes may be orthonormal orbital planes, or substantially orthonormal planes, i.e., they may be (substantially) orthogonal to each other. For example, an angle between orbital planes may be 90°±3°.

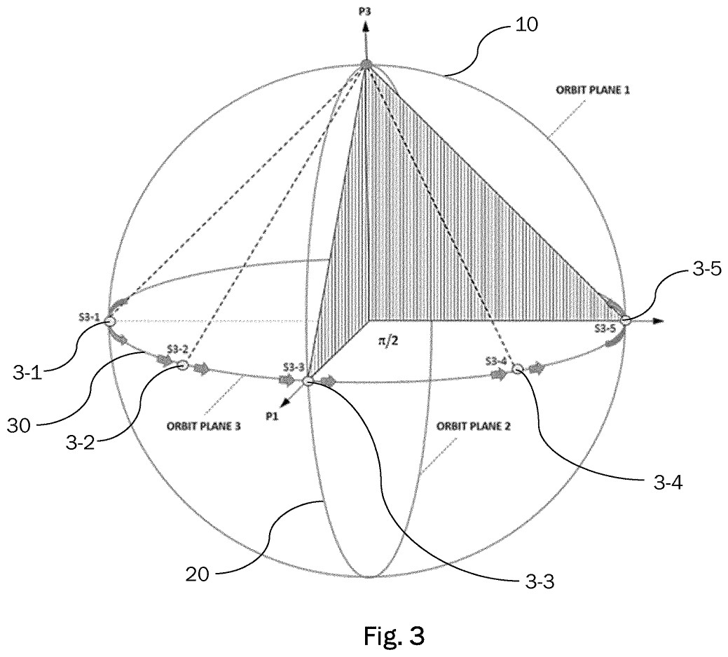

This (non-limiting) assumption yields to the simplified geometry shown in the example of FIG. 3 with three (substantially) orthogonal orbital planes 10, 20, 30. Orbital plane 3 is shown to have a plurality of satellites 3-1, 3-2, 3-3, 3-4, and 3-5. This configuration allows to draw the following conclusions from geometrical considerations, for any satellite with arbitrary position X=(P₁, P₂, P₃).

Simultaneous ranging measurements from a pair of in-plane satellites at orthonormal-points (e.g., SY-1, SY-5) to a satellite (X) on a different orbital plane can provide information on the X position error projection on the orbital plane defined by these three satellites. The standard-deviation-error-conic may have minimum area due to ortho-normality of points.

Simultaneous ranging measurements from four in-plane satellites at orthonormal-points and orthogonal diameters (e.g., {SY-1, SY-5}, {SY-3, SY-7}) to a satellite (X) on a different orbital plane can provide information on the X position error projection on two orbital planes (orthonormal planes). In both cases the associated standard-deviation-error-conic may have minimum area and the standard-deviation-error-conics may be orthogonal.

For every satellite X, whichever its position, there are two sets of four in-plane satellites at orthonormal-points and orthogonal diameters, at each orbital plane (orthonormal plane).

For example, the aforementioned two sets of four in-plane satellites at orthonormal points and orthogonal diameters may be the following for each orbital plane (orthonormal plane):
[Orbital Plane-1]: Orthonormal-planes from orthonormal points:
   Set 1A: [S1-1↔X, S1-5↔X]; arbitrary rotation around P1 compatible.
      [S1-3↔X, S1-7↔X]
   Set 1B: [S1-2↔X, S1-6↔X]; arbitrary rotation around P1 compatible.
      [S1-4↔X, S1-8↔X]
[Orbital Plane-2]: Orthonormal-planes from orthonormal points:
   Set 2A: [S2-1↔X, S2-5↔X]; arbitrary rotation around P2 compatible.
      [S2-3↔X, S2-7↔X]
   Set 2B: [S2-2↔X, S2-6↔X]; arbitrary rotation around P2 compatible.
      [S2-4↔X, S2-8↔X]
[Orbital Plane-3]: Orthonormal-planes from orthonormal points:
   Set 3A: [S3-1↔X, S3-5↔X]; arbitrary rotation around P3 compatible.
      [S3-3↔X, S3-7↔X]
   Set 3B: [S3-2↔X, S3-6↔X]; arbitrary rotation around P3 compatible.
      [S3-4↔X, S3-8↔X]

The above findings may be exploited for establishing a scheme of establishing inter-satellite links between satellites of the given constellation of satellites that allows, among others, obtaining improved (e.g., more accurate) ranging information among the satellites of the constellation.

With the current technology, a payload able to physically materialize the above set of connections in accurate manner may be prohibitive from one or more of cost, mass, power, and envelope perspective. Fortunately, this may also be unnecessary, given that the stability over time of the position errors, on the orbit intrinsic reference frame {Along, Across, Radial}, is below 25 μm/s, which allows to gather the measurements in Set 1A, Set 2A & Set 3A over different time slots. In other words, the ISL connections from the satellites of one set of satellites to satellite X may be established in subsequent time slots, for example minimizing the time necessary for realizing ISL connections for the set.

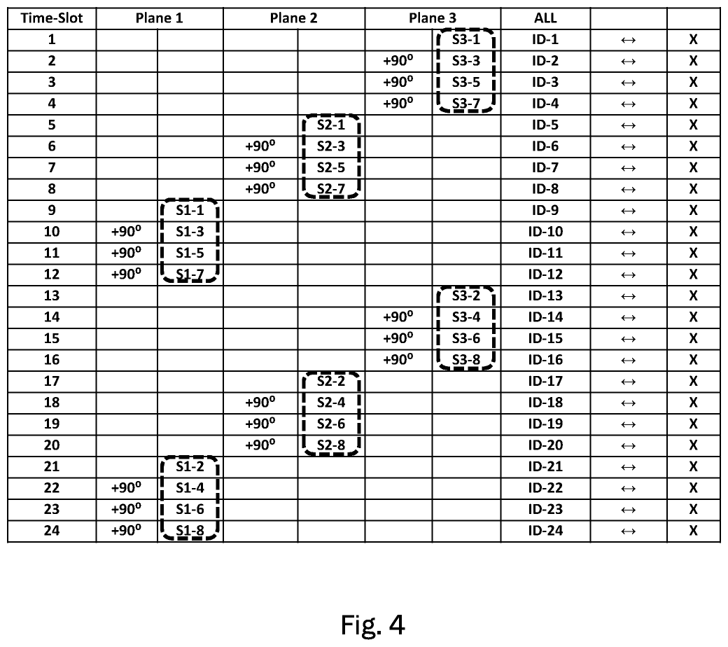

An example of such scheme (i.e., a sequence of connections to the given satellite X) that realizes the ISL connections for each set of satellites in consecutive time slots is shown in the table of FIG. 4. This connectivity scheme may be targeted for every satellite among the constellation. Notation Sx-y indicates the y-th satellite in the x-th orbital plane. For the example of Galileo, x=1, . . . , 3 and y=1, . . . , 8. Notation ID-z indicates unique identification numbers of the satellites (e.g., identifiers for the purpose of connection tables). For the example of Galileo, z=1, . . . , 24. Each line of this table defines a bijection between the given satellite X and one of the (other) satellites Sx-y of the constellation for the respective time slot.

In general, the ISL connectivity scheme may assume that each full cycle (after which the connectivity scheme may repeat from the start) is sub-divided into or comprises at least three periods of time (time periods). Therein, each period of time may include multiple (e.g., four) time slots. Using three periods of time may be sufficient for obtaining accurate ranging information among the satellites of the constellation, whereas using six periods of time may be chosen to achieve improved redundancy (and eventually, accuracy) of the ranging measurements. Using six periods of time may have the additional advantage of enabling a ring topology of ISLs, as described in more detail below.

The example of FIG. 4 assumes that a full cycle spans 24 time slots (e.g., one for each of 24 satellites in the constellation; in general, there may be N time slots for N satellites) and comprises six periods of time, in which time period 1 (first time period) includes time slots 1 to 4, time period 2 (second time period) includes time slots 5 to 8, time period 3 (third time period) includes time slots 9 to 12, time period 4 (fourth time period) includes time slots 13 to 16, time period 5 (fifth time period) includes time slots 17 to 20, and time period 6 (sixth time period) includes time slots 21 to 24. If a scheme with only three periods of time is envisaged (e.g., with time slots 1 to 12), the scheme may return to time period 1 after time period 3 ends. These time periods are understood to be consecutive time periods, in the sense that they immediately (or seamlessly) follow one to another. For example, the second time period may immediately follow the first time period and the third time period may immediately follow the second time period, and so forth. Analogous considerations may apply to the time slots.

The connectivity scheme in FIG. 4 is targeted for (e.g., applies to) every satellite among the constellation of satellites. That is, for a given satellite, the satellite may establish an ISL with satellite S3-1 in time slot 1, with satellite S3-3 in time slot 2, with satellite S3-7 in time slot 3, and so forth.

Here and in the following, it is understood that establishing the ISLs may be subject to a line of sight existing between the satellites involved. Specifically, establishing the inter-satellite links may be subject to visibility of the satellites from one another (e.g., subject to the absence of mutual eclipse) and, needless to say, that the given satellite does not coincide with the respective satellite to which the ISL is to be established. Accordingly, any statements in the following to the end that an ISL is established are to be seen under the condition that establishing the ISL is possible between the satellites involved. Accordingly, the wording that an ISL is established between two satellites is to be understood in the sense that it is attempted or foreseen to establish the ISL.

The ISL connectivity scheme illustrated in FIG. 4 has the following properties:
Quasi-simultaneous ranging measurements from Set 1A (in the first time period), allowing for solving {P2, P3} position errors, and for aiding solving {P1} position error.
Quasi-simultaneous ranging measurements from Set 2A (in the second time period), allowing for solving {P1, P3} position errors, and for aiding solving {P2} position error.
Quasi-simultaneous ranging measurements from Set 3A (in the third time period), for solving {P₁, P₂} position errors, and for aiding solving {P₃} position error.

For redundancy purposes, the ISL connectivity scheme of FIG. 4 may have the further properties:
Quasi-simultaneous ranging measurements from Set 1B (e.g., in the fourth time period), allowing for solving {P2, P3} position errors, and for aiding solving {P1} position error.
Quasi-simultaneous ranging measurements from Set 2B (e.g., in the fifth time period), allowing for solving {P1, P3} position errors, and for aiding solving {P2} position error.
Quasi-simultaneous ranging measurements from Set 3B (e.g., in the sixth time period), allowing for solving {P1, P2} position errors, and for aiding solving {P3} position error.

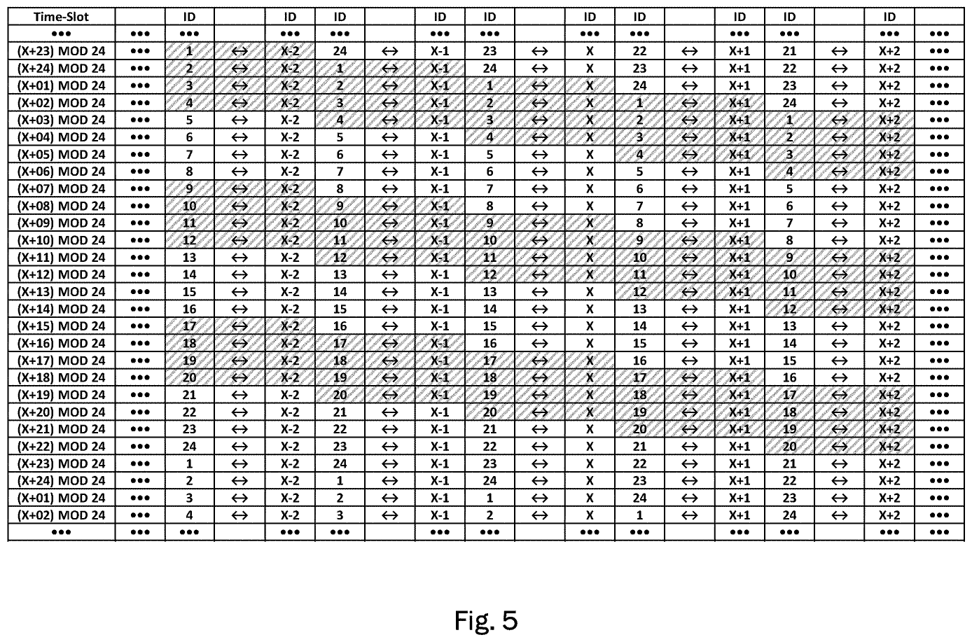

As noted above, every satellite in the constellation of satellites shall consecutively go through the ISLs according to the above ISL connectivity scheme. To realize an integrated scheme in which this is the case for all satellites, a connectivity table or connection table may be derived for example in line with publication Advances in Space Research. Volume 47, Issue 5, 1 Mar. 2011, Pages 786-801, which is herewith incorporated by reference in its entirety. In the resulting connectivity table, the ISL connections of FIG. 4 may be realized for every satellite X, at different time slots, wherein all possible connections are realized in minimum time (e.g., after nₛₐₜ=N time slots, with nₛₐₜ denoting the number of satellites in the constellation). An example of such connectivity table or connectivity scheme is illustrated in the table of FIG. 5.

In this table, X can take values between 1 and 24 (i.e., between 1 and N in general, where N is the total number of satellites in the constellation). Any numbers are understood to be modulo 24 (i.e., modulo N, or ⊙N in the notation of the Annex). It is further understood that FIG. 5 only shows a clipping of the full connectivity table that may extend in all four directions (with numbers for satellites and time slots modulo N).

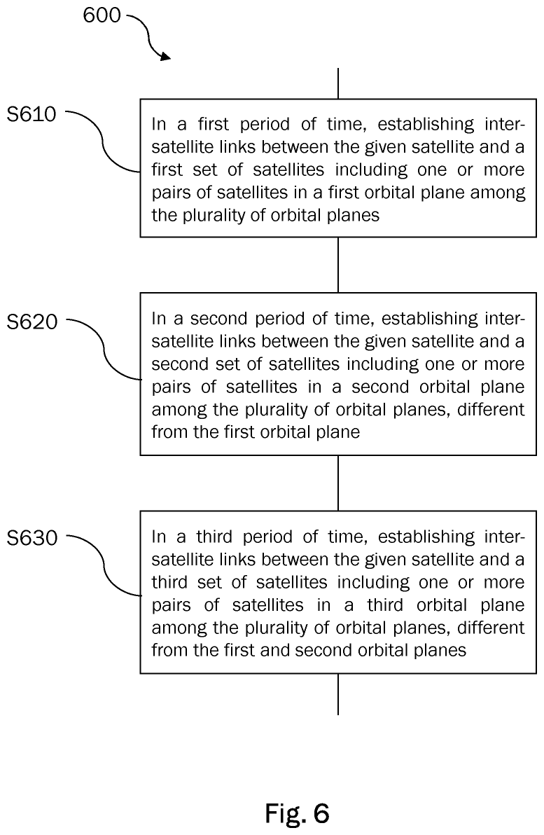

In general, the present disclosure proposes a method 600 of establishing ISLs between satellites of a constellation of satellites as shown in the flowchart of FIG. 6. The satellites are assumed to be arranged in a plurality of orbital planes in pairs of satellites orbiting Earth in substantially diametral orbit positions (orthonormal positions). For a given satellite among the constellation of satellites, the method comprises steps S610 to S630. In some implementations, these steps may be performed for each of the satellites of the constellation. In such case, in line with the example of FIG. 5, it is understood that each satellite may have its own sequence of time periods (e.g., first to third time periods), wherein time periods for different satellites may start at different times.

At step S610, in a first period of time, inter-satellite links are established between the given satellite and a first set of satellites including one or more pairs of satellites in a first orbital plane among the plurality of orbital planes. The first set of satellites may be any one of sets 1A, 2A, 3A defined above, for example.

At step S620, in a second period of time, inter-satellite links are established between the given satellite and a second set of satellites including one or more pairs of satellites in a second orbital plane among the plurality of orbital planes. The second orbital plane is different from the first orbital plane. The second set may be any one of the remaining sets among sets 1A, 2A, 3A, for example.

At step S630, in a third period of time, inter-satellite links are established between the given satellite and a third set of satellites including one or more pairs of satellites in a third orbital plane among the plurality of orbital planes. The third orbital plane is different from the first and second orbital planes. The third set may be the remaining one among sets 1A, 2A, 3A, for example.

Here, each of the first to third sets of satellites (e.g., sets 1A, 2A, 3A) may include equal numbers of satellites. In one example, the first to third sets of satellites may each include two pairs of satellites, i.e., four satellites in total. In each of the first to third sets of satellites, neighboring satellites, along orbit, may be shifted from each other along orbit by 90° in argument of latitude angle.

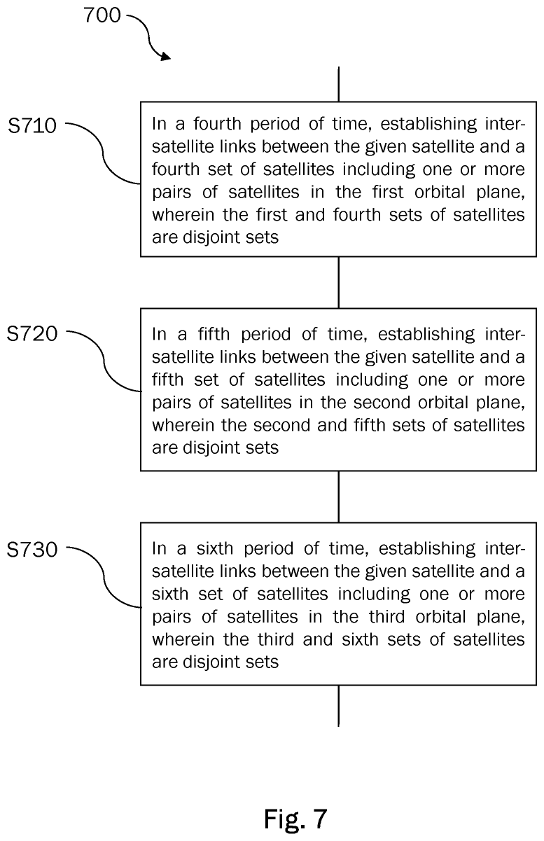

FIG. 6 shows an example method using three time periods. If six time periods are used, method 600 would have to be followed by steps S710 to S730 of method 700 shown in the flowchart of FIG. 7 before completing the full cycle. That is, a method using six time periods (e.g., for achieving redundancy) would comprise, for a given satellite, each of steps S610 to S630 and S710 to S730.

At step S710, in a fourth period of time, inter-satellite links are established between the given satellite and a fourth set of satellites including one or more pairs of satellites in the first orbital plane. The first and fourth sets of satellites (both including satellites of the same orbital plane) are disjoint sets. The fourth set of satellites may be, for example, any one of sets 1B, 2B, 3B defined above, noting that its satellites should be in the same orbital plane as the satellites of the first set of satellites. For example, if the first set of satellites is set 3A, the fourth set of satellites would be set 3B, and so forth.

At step S720, in a fifth period of time, inter-satellite links are established between the given satellite and a fifth set of satellites including one or more pairs of satellites in the second orbital plane. The second and fifth sets of satellites are disjoint sets. The fifth set may be, for example, any one of the remaining sets among sets 1B, 2B, 3B, noting that its satellites should be in the same orbital plane as the satellites of the second set of satellites. For example, if the second set of satellites is set 2A, the fifth set of satellites would be set 2B, and so forth.

At step S730, in a sixth period of time, inter-satellite links are established between the given satellite and a sixth set of satellites including one or more pairs of satellites in the third orbital plane. The third and sixth sets of satellites are disjoint sets. The sixth set may for example be the remaining one among sets 1B, 2B, 3B, noting that its satellites should be in the same orbital plane as the satellites of the third set of satellites. For example, if the third set of satellites is set 1A, the sixth set of satellites would be set 1B, and so forth.

Again, each of the fourth to sixth sets of satellites (e.g., sets 1B, 2B, 3B) may include equal numbers of satellites. In one example, the fourth to sixth sets of satellites may each include two pairs of satellites, i.e., four satellites in total. In each of the fourth to sixth sets of satellites, neighboring satellites, along orbit, may be shifted from each other along orbit by 90° in argument of latitude angle.

The satellites of the fourth to sixth sets of satellites may be shifted along orbit from the satellites in the first to third sets of satellites, respectively, by 45° in argument of latitude angle.

With the above definitions of the first to sixth sets of satellites, the constellation would be a constellation of 24 satellites in total, 8 per orbital plane, shifted from each other along orbit by 45° in argument of latitude angle.

As noted above, the ISL connections in each time period (e.g., in the first to sixth time periods) do not necessarily have to be established simultaneously. Rather, they may be established one after another, in a plurality of consecutive time slots within the respective time periods.

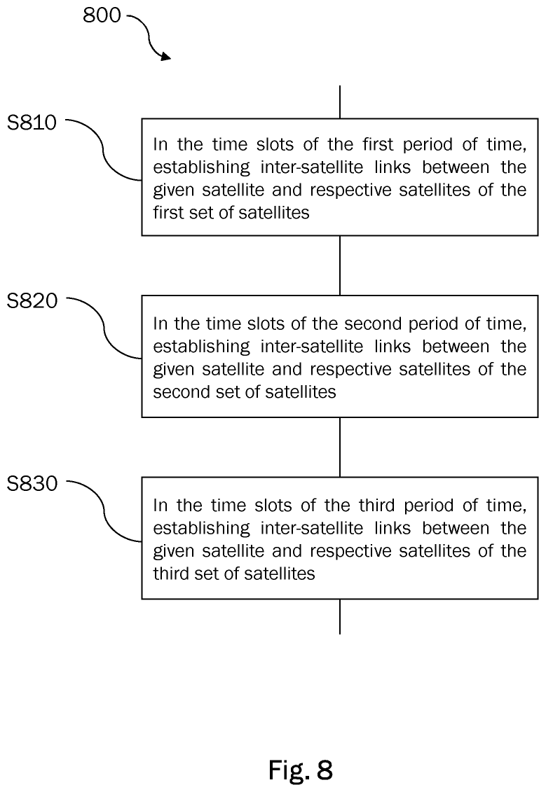

Accordingly, in one implementation the first to third periods of time are subdivided into sequential time slots of equal duration. This is done in such manner that the first period of time includes a respective time slot for each of the satellites of the first set of satellites, the second period of time includes a respective time slot for each of the satellites of the second set of satellites, and the third period of time includes a respective time slot for each of the satellites of the third set of satellites. With this setup, method 600 of establishing ISL connections may take the form of method 800 illustrated in FIG. 8. Method 800 comprises steps S810 to S830, which may implement steps S610 to S630, respectively, of method 600.

At step S810, in the time slots of the first period of time, inter-satellite links are established between the given satellite and respective satellites of the first set of satellites.

At step S820, in the time slots of the second period of time, inter-satellite links are established between the given satellite and respective satellites of the second set of satellites.

At step S830, in the time slots of the third period of time, inter-satellite links are established between the given satellite and respective satellites of the third set of satellites.

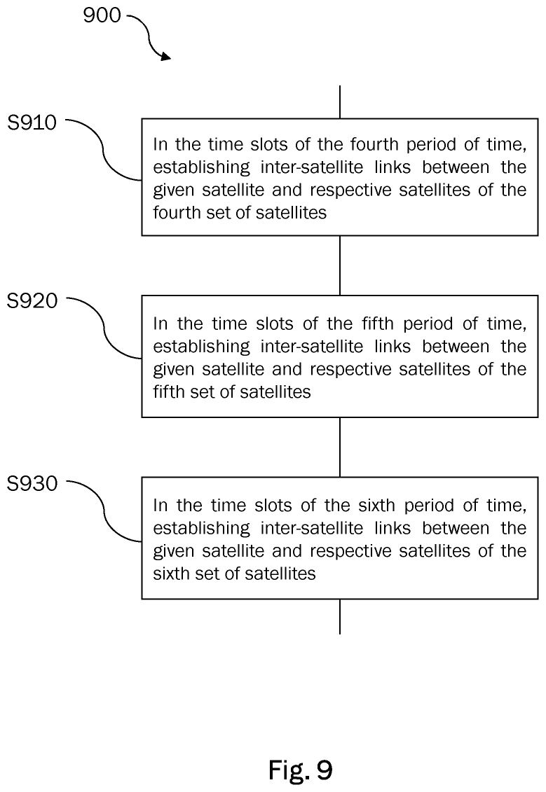

FIG. 8 shows an example method using three time periods, each subdivided into time slots. If six time periods are used, also the fourth to sixth periods of time are subdivided into sequential time slots of equal duration. This is done in such manner that the fourth period of time includes a respective time slot for each of the satellites of the fourth set of satellites, the fifth period of time includes a respective time slot for each of the satellites of the fifth set of satellites, and the sixth period of time includes a respective time slot for each of the satellites of the sixth set of satellites. Further, method 800 would have to be followed by steps S910 to S930 of method 900 shown in the flowchart of FIG. 9 before completing the full cycle. That is, a method using six time periods (e.g., for achieving redundancy) would comprise, for a given satellite, each of steps S810 to S830 and S910 to S930. Steps S910 to S930 of method 900 may implement steps S710 to S730, respectively, of method 700.

At step S910, in the time slots of the fourth period of time, inter-satellite links are established between the given satellite and respective satellites of the fourth set of satellites;

At step S920, in the time slots of the fifth period of time, inter-satellite links are established between the given satellite and respective satellites of the fifth set of satellites.

And at step S930, in the time slots of the sixth period of time, inter-satellite links are established between the given satellite and respective satellites of the sixth set of satellites.

On the assumption that the satellites of the constellation of satellites have consecutive numbers assigned thereto, ranging from 1 to N, starting with the satellites of the first set of satellites and followed, in this order, by the satellites of the second to sixth sets of satellites, where N is the number of satellites in the constellation of satellites (e.g., N=24), and that the method proceeds in cycles of N consecutive time slots each, methods 800 and 900 described above can be implemented by method 1000 with step S1010 described below.

At step S1010 (which may be seen as an implementation of steps S810, S820, S830 or of steps S810, S820, S830, S910, S920, S930), in an n-th time slot of the N time slots, inter-satellite links are established between an s-th satellite and an (n−s)-th satellite, where s runs from 1 to N and wherein numbers of satellites are assumed to be modulo N. Here, the time-slot index n can take values from 1 to N. Index s is a running index that is run through for each time slot, i.e., it is understood that multiple inter-satellite links are established per time slot. In other words, inter-satellite links are established for all s∈{1, . . . , N}. Thereby, a connectivity scheme in line with FIG. 5 can be established.

It is also noted that the above may include double-counts for some n, i.e., a pair of satellites (i, j) may also appear as (j, i) in the aforementioned inter-satellite links. It is understood that for a given satellite pair (i, j) only one ISL is established in the given time slot.

Depending on whether redundancy is desired, N may be chosen so as to span all six sets of satellites (e.g., N=24), or to only span the first three sets of satellites (e.g., N=12).

The ISL connections established by any of the methods, schemes, and techniques described throughout the disclosure may be used for determining ranging information relating to relative distances between the satellites (e.g., between the given satellite and respective other satellites) of the constellation of satellites. This ranging information can then be used for determining an estimate of a position of the given satellite relative to the other satellites of the constellation of satellites. The estimate of the position may be based on a collection/aggregate of the ranging information/measurements. In general, ranging information may be determined based on any established inter-satellite link, and the collected/accumulated ranging information may be used for estimating relative positions of the satellites in the constellation of satellites.

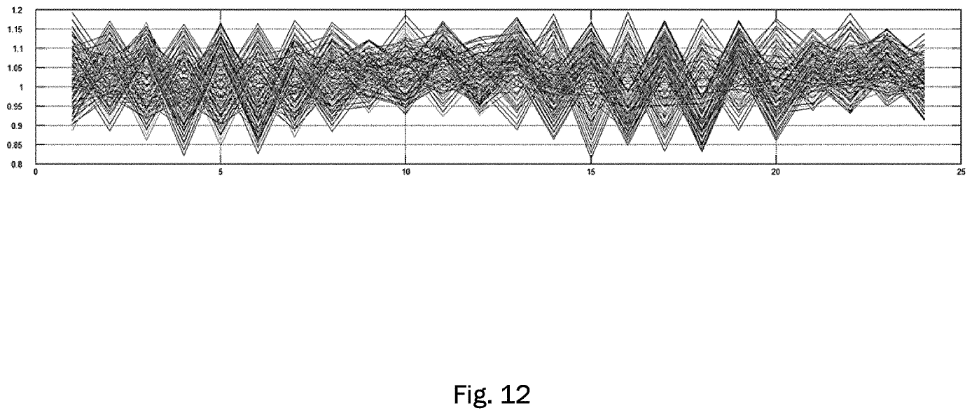

The practical dependency of the Orbit and Clock Determination (OCD) accuracy, with respect to the orbital-plane orthonormality assumption is very small compared to the dependency with respect the connectivity sequence. For the example of a constellation with N=24 satellites, this is shown in the diagram of FIG. 12. There, the horizontal axis indicates the satellites, whereas the vertical axis indicates the OCD accuracy. Differently shaded lines relate to different deviations from the orthonormality assumption, for an inclination of the first orbital plane in the range between 52° and 58°.

### Ring-Circuit Topologies

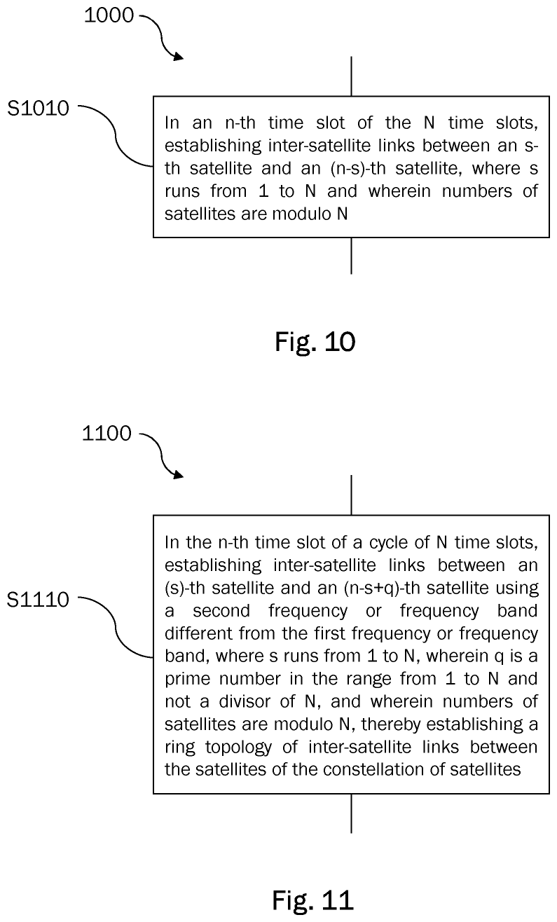

The above connectivity scheme, which is optimized from OCD considerations, may be embedded within an extended connectivity scheme that allows to ensure a ring topology of ISL connections among the satellites of the constellation within each time slot. Thereby, the extended connectivity scheme can ensure, with adequate design (influencing on-ground and on-board processing), useful properties from mission/control data dissemination standpoints. Specifically, the proposed extended connectivity scheme, when applied to satellites that are able to simultaneously establish two inter-satellite links on different frequencies (e.g., Galileo Next Generation, G2G, satellites) can ensure a network ring-circuit topology by superposing, with a shift in time, two connectivity schemes as described above (e.g., as per the connectivity table in FIG. 5 or the method 1000 of FIG. 10). This requires making the difference (corresponding to the aforementioned shift in time) between the respective time indexes in the connectivity table for each link a prime number, excluding any divisors of the number N of satellites other than 1 (this prime number being denoted & or q). By this ring-circuit topology, quasi real-time communication capability among the satellites of the constellation can be ensured. This can be achieved even with a single gateway, with enhanced performance in case of multiple gateways.

For establishing such ring-circuit topology of ISLs in each time slot, the ISLs established by the aforementioned methods (e.g., method 1000 of FIG. 10) in each time slot of a cycle may use a first frequency or frequency band. Then, in addition to the ISLs established in the first frequency or frequency band, ISLs in a second frequency or frequency band may be established. Each satellite may establish ISLs in the first frequency by cycling through one of the above schemes. Further, each satellite may establish ISLs in the second frequency by cycling through the same scheme, but with an offset (shift) in units of time slots. Choosing this offset as the above-defined prime number 8 or q will achieve the ring-circuit topology among the satellites of the constellation. This offset scheme may be described by method 1100 shown in the flowchart of FIG. 11, which is to be performed in conjunction with method 1000 of FIG. 10.

At step S1110 of method 1100, in the n-th time slot of the cycle of N time slots, inter-satellite links between an (s)-th satellite and an (n−s+q)-th satellite are established using a second frequency or frequency band different from the first frequency or frequency band, where s runs from 1 to N, wherein q is the aforementioned prime number in the range from 1 to N and not a divisor of N. Again, numbers of satellites are understood to be modulo N. Moreover, considerations in analogy to those for Step S1010 may apply.

Performing both steps S1010 and S1100 in the n-th time slot will establishing a ring topology of inter-satellite links between the satellites of the constellation of satellites.

Here, it is to be noted that for obtaining ranging information between satellites, it may not be relevant which satellite in an established ISL is transmitting and which is receiving. In a general case, either satellite may be in transmit and the other satellite may be in receive. The two satellites may in principle also exchange roles in a given time slot or period of time, to both be in transmit first and the in receive, or vice versa. On the other hand, for establishing a ring network topology, it may be preferable to ensure data flow along the satellites forming the ring. Therein, the “direction” of each established ISL (i.e., the assignment of the satellites involved in an ISL (i, j) to transmit and receive) may be made in the following manner. For example, a first ISL (i₁, j₁) on the first frequency (or alternatively, the second frequency; in general, a starting frequency) can be arbitrarily selected. Then, i₁ can be placed in transmit and j₁ can be placed in receive. Next, the ISL involving j₁ on the other frequency is identified. The other satellite i₂ in that pair is placed in receive, and j₁ is placed in transmit, corresponding to connection (j₁, i₂). Then, the ISL involving i₂ on the starting frequency is identified, and so forth.

The connectivity schemes described above may need to be re-adjusted in certain cases, while preserving the ring topology, to account for unfeasible connections. For example, connections between satellites may be unfeasible due to an eclipse condition, either between satellites on the same orbital plane (which may be a permanent mutual eclipse) or in different planes (which may be a time-dependent mutual eclipse). After such re-adjustments, described hereafter, all connections can be realized and a network ring topology can always be established.

Accordingly, treatment of unfeasible connections, for example due to mutual eclipses between satellites, both in-plane and inter-plane will be described next.

### Treatment of In-Plane Eclipses

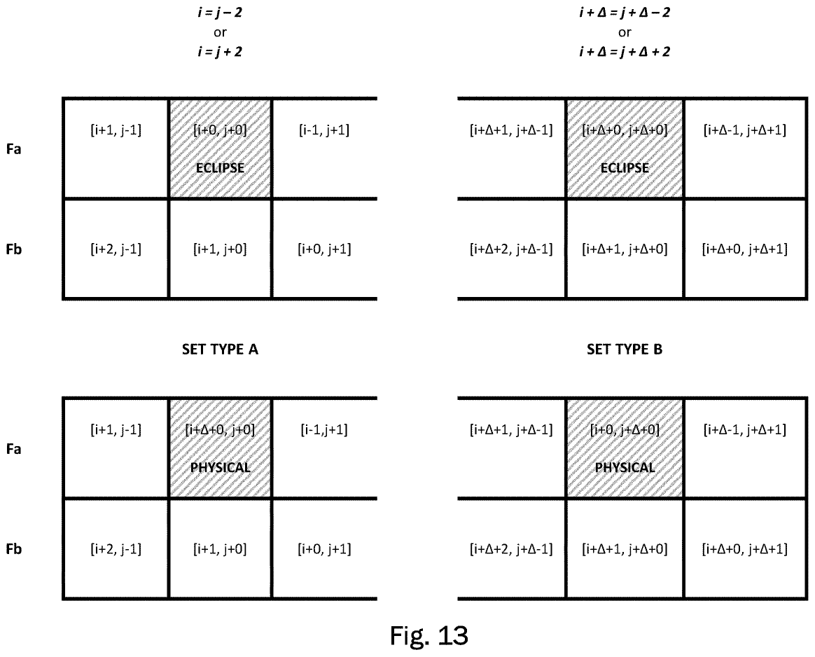

For any satellite with assigned index j (assuming the above numbering scheme), either the satellite i=j+2 or i=j−2 is on the same plane, with 180° lead or lag in the argument of latitude, and therefore not visible from satellite j due to Earth obstruction. Defining a parameter Δ=N/2, the connection [i, j] can then be replaced by another in-plane connection to a satellite from the set in that plane to which the satellite j does not belong to (as shown in the example of FIG. 13), concretely [i+Δ, j] (or [j+Δ, j] depending on the case), which is always feasible because only one in-plane connection is not realizable from satellite j. Analogously, the original connection [i+Δ, j+Δ] is replaced by the connection [i, j+Δ] (or [i, i+Δ] depending on the case), which is always feasible because only one in-plane connection is not realizable from a satellite i. This adaptation may be hardcoded into the connectivity matrix generated by the Ground Segment. By reversing the original flow in one of the unconnected paths, this adaptation preserves the ring-network topology.

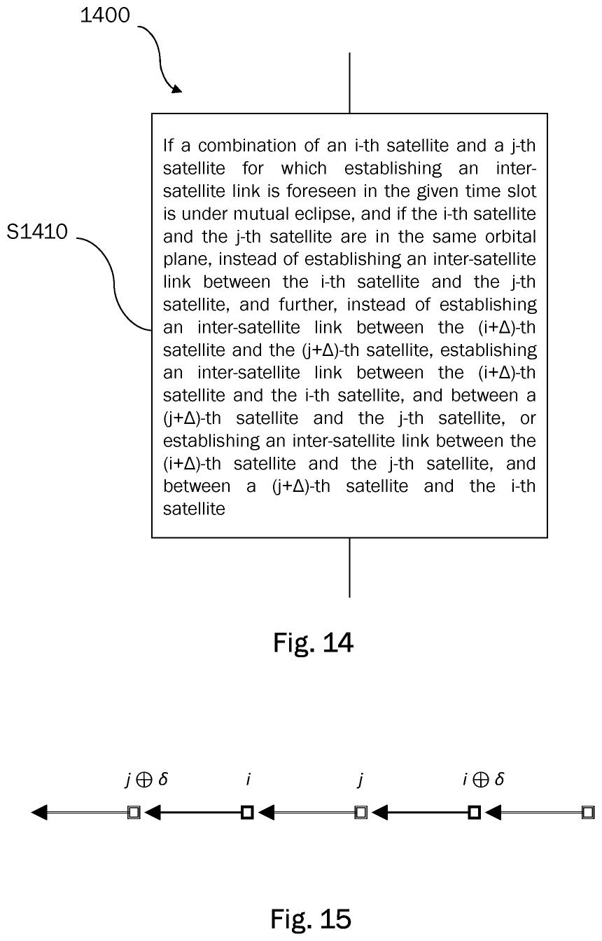

An example of a method 1400 for treating in-plane mutual eclipses is shown in the flowchart of FIG. 14. This method may be used in the context of any of the connectivity schemes/methods described above, assuming the aforementioned indexing of the satellites of the constellation of satellites. Step S1410 of method 1400 may be performed for each time slot.

At step S1410, if a combination of an i-th satellite and a j-th satellite for which establishing an inter-satellite link is foreseen in the given time slot is under mutual eclipse, and if the i-th satellite and the j-th satellite are in the same orbital plane, instead of establishing an inter-satellite link between the i-th satellite and the j-th satellite, and further, instead of establishing an inter-satellite link between an (i+Δ)-th satellite and a (j+Δ)-th satellite, an inter-satellite link is established between the (i+Δ)-th satellite and the i-th satellite, and between the (j+Δ)-th satellite and the j-th satellite, or an inter-satellite link is established between the (i+Δ)-th satellite and the j-th satellite, and between the (j+Δ)-th satellite and the i-th satellite. The choice between the alternatives for the replacement ISLs may be made so as to reverse the direction of the data flow for a subset of arcs. Here and in the following, as noted above, mutual eclipse may mean that there is no line of sight between the satellites involved.

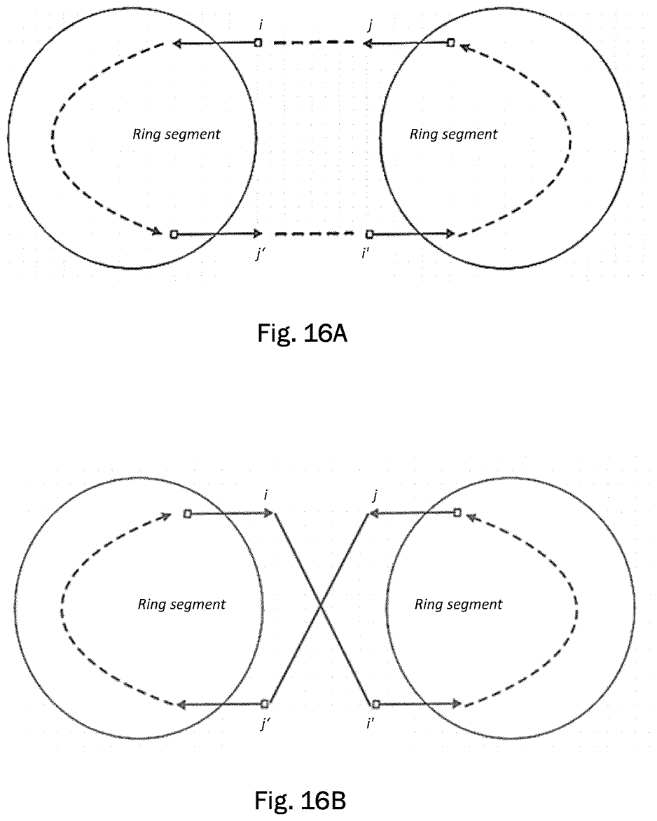

Next, a proof of feasibility of the above treatment of in-plane mutual eclipses will be presented. For this, reference is also made to FIG. 15, FIG. 16A, and FIG. 16B, which schematically illustrate examples of ISL connection arcs in the method of FIG. 14. The proof uses the notation given in the Annex.

### Proof:

1.1: Let [i, j] be an in-plane connection (in the orbit plane P) blocked by Earth. Then the connection [i+Δ, j+Δ], blocked by Earth, is foreseen (by the initial connectivity matrix) simultaneously and on the same frequency, between two other satellites of the same orbit plane P.

The [i+Δ, j+Δ] connection is
simultaneous and on the same frequency, because [i+Δ]⊕[j+Δ]=i ⊕j.
an in-plane connection in the orbit plane P, because satellite i+Δ is on the same plane as satellite i, and satellite j+Δ is on the same plane as j.
blocked by Earth, because satellite i+Δ is rotated/offset by 45° along orbit with respect to satellite i, and satellite j+Δ is rotated/offset by 45° along orbit with respect to satellite j, and therefore the difference of the argument of latitude between satellites i+Δ and j+Δ is equal to the difference of the argument of latitude between satellites i and j.

1.2: Let [i, j] be an arbitrary connection of a connected network-topology built as described above or in the Annex, with associated lag/offset 8, and let j be on transmit towards i. Then, the successive nodes along which data is transported (as illustrated in the example of FIG. 15, which shows the relationship between the nodes of subsequent arcs) are {j, i, j⊕δ, i ⊕[−δ], j⊕2δ, i ⊕[−2δ], j⊕3δ, i ⊕[−3δ], . . . }.

Satellite i can be simultaneously on receive in the [i, j] connection on one frequency, and on transmit in the [j⊕δ, i] connection on the other frequency, because [j⊕δ]⊕i=j⊕[δ⊕i]=j⊕[i⊕δ]=[j⊕i]⊕δ.

Satellite j can be simultaneously on transmit in the [i, j] connection on one frequency, and on receive in the [j, i δ] connection on the other frequency, because j⊕[i ⊕δ]=[j⊕i]@δ.

1.3: Let [i, j] be an arbitrary connection of a connected network-topology built as described in the Annex, with associated lag δ, and let j be on transmit towards i; then in the connection [j⊕Δ, i ⊕Δ], j⊕Δ can be on transmit towards i ⊕Δ.

Because of Proposition 1.2 the succession of nodes seen by the data is {j, i, j⊕δ, i⊕[−δ], j⊕2δ, i⊕[−2δ], j⊕3δ, i⊕[−3δ], . . . }, and eventually arrives at the node j⊕ΔA because there always exists an integer m such that j⊕mδ=j⊕A, and the succession ensures access to all nodes (thereby resulting in a ring network-topology). At that node, the next arc necessarily ends in i ⊕[−mδ]=i ⊕[−Δ]=i ⊕Δ, because of succession construction. Since every node is visited only once, i ⊕Δ has not been visited before. Therefore, in FIG. 16A, which shows ISL [i, j] which is under eclipse and ISL [j′, i′] which is not necessarily under eclipse but may be broken to address the eclipse in [i, j], and FIG. 16B, which shows respective ISLs replacing the ISLs of FIG. 16A, relationships j′=j⊕Δ and i′=i ⊕Δ hold.

Furthermore, because i ⊕Δ belongs to the circuit, we have i @Δ=i ⊕[−kδ] for some k, then 1≤m×N−kδ≤N, and k=(2N−1)Δ/δ, with m being the lowest natural number which makes k a natural number. Because 1≤δ≤N and δ is a prime number, (2m−1)=δ, or equivalently m=(δ+1)/2.

1.4: Let [i, j] be an arbitrary connection of a connected network-topology built as described in the Annex, with associated lag δ, and let j be on transmit towards i. If [i, j] is an in-plane connection blocked by Earth, then replacing the connections {[i, j], [i+Δ, j+Δ]} by the in-plane connection {[i+Δ, i], [j+Δ, j]} ensures a ring-network topology, asuming all other connections are realizable, as shown in FIG. 16A and FIG. 16B. The modification reverses the direction of data flow between nodes i and j′.

1.5: Furthermore, if proposition 1.1 holds, but propositions 1.2, 1.3, and 1.4 were not to hold, then out of the two following reconnections {[i+Δ, j], [i, j+Δ]} and {[j+Δ, j], [i, i+Δ]}, the one reversing the direction of data flow for a subset of arcs ensures a ring topology, as shown in FIG. 16A and FIG. 16B.

### Treatment of Inter-Plane Eclipses

For a satellite with index j, when its orbital position lies in the vicinity of the intersection between its orbital plane (with index B) and another orbital plane (with index A or C), its visibility on a satellite with index i from that second orbital plane (with index A or C) also in the vicinity of the same intersection may not be possible, since these satellites would be close to diametrically opposed. The connection [i, j] can then be replaced by an in-plane connection to a satellite from the set in the same orbital plane to which the satellite j does not belong to. Analogously, the original connection of the latter satellite can be replaced by another in-plane connection. This adaptation may have to be softcoded in the satellites' on-board software and may require monitoring the eclipse condition. The adaptation may further require a coordinated logic for selecting an in-plane connection preserving the ring-network topology, as explained in more detail below. Notably, the monitoring of the eclipse condition may require an additional on-board rounding-computation strategy to ensure that the occurrence of an eclipse is declared coherently at constellation level.

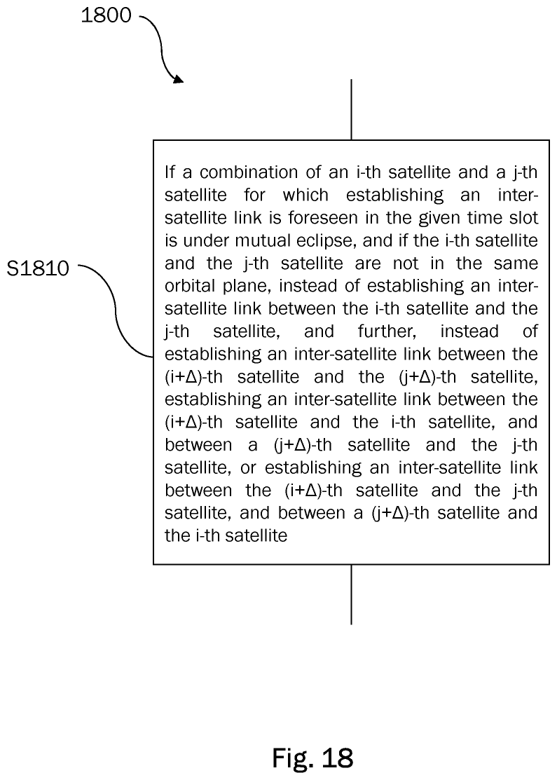

An example of a method 1800 for treating inter-plane mutual eclipses is shown in the flowchart of FIG. 18. This method may be used in the context of any of the connectivity schemes/methods described above, assuming the aforementioned indexing of the satellites of the constellation of satellites. Step S1810 of method 1800 may be performed for each time slot.

At step S1810, if a combination of an i-th satellite and a j-th satellite for which establishing an inter-satellite link is foreseen in the given time slot is under mutual eclipse, and if the i-th satellite and the j-th satellite are not in the same orbital plane, instead of establishing an inter-satellite link between the i-th satellite and the j-th satellite, and further, instead of establishing an inter-satellite link between an (i+Δ)-th satellite and a (j+Δ)-th satellite, an inter-satellite link is established between the (i+Δ)-th satellite and the i-th satellite, and between the (j+Δ)-th satellite and the j-th satellite, or an inter-satellite link is established between the (i+Δ)-th satellite and the j-th satellite, and between the (j+Δ)-th satellite and the i-th satellite. The choice between the alternatives for the replacement ISLs may be made so as to reverse the direction of the data flow for a subset of arcs.

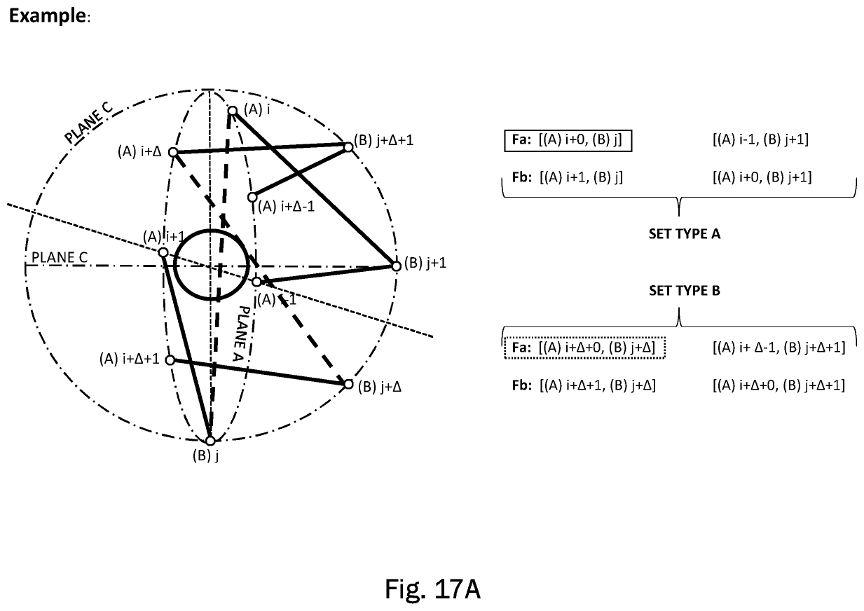

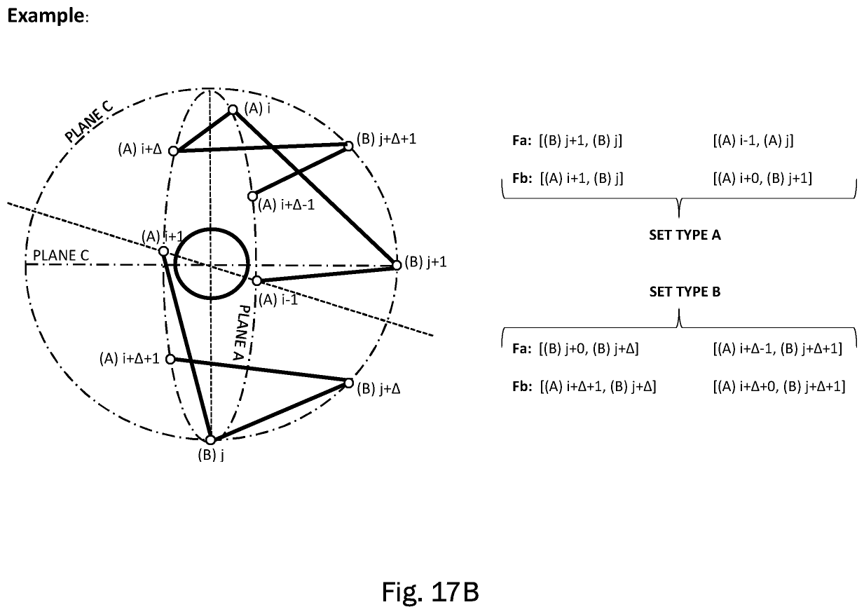

Next, a proof of feasibility of the above treatment of inter-plane mutual eclipses will be presented. For this, reference is also made to FIG. 17A and FIG. 17B, which schematically illustrate examples of replacement of ISL connection in line with the method of FIG. 18, as well as to FIG. 16A and FIG. 16B. The proof uses the notation given in the Annex.

### Proof:

1.6: Let [i, j] be an inter-plane connection blocked by Earth. Then the connection [i+Δ, j+Δ], as foreseen by the initial connectivity matrix, is simultaneous and on the same frequency, and is an inter-plane connection between two other satellites from the same respective orbital planes.

The [i+Δ, j+Δ] connection is:
simultaneous and on the same frequency, because [i ⊕Δ]⊕[j⊕Δ]=i ⊕j.
an inter-plane connection between two other satellites is between the respective same orbital planes, because satellite i+Δ is on the same plane as i, and satellite j+Δ is on the same plane as j.

1.7: Let [i, j] be an inter-plane connection blocked by Earth. Then one out of the two following reconnections {[i+Δ, j], [i, j+Δ]} and {[j+Δ, j], [i, i+Δ]}, in particular the one reversing the direction of data flow for a subset of arcs, ensures a ring topology (as shown in FIG. 16A and FIG. 16B).

### Treatment of Multiple Eclipses of Whichever Type

Because the above-described modifications alter the sequence of visited nodes, the success for a recursive application of the above described methods in a case with multiple eclipses cannot be concluded from the above proofs when relying on the prior knowledge on the sequence of visited nodes. However, the success of a recursive application can be ensured by the above methods when avoiding conclusions and subsequent decisions based on the prior knowledge on the sequence of visited nodes.

As a general guideline, treatment of in-plane eclipses may be hardcoded into the satellite's connectivity tables. Further, when successively dealing with multiple inter-plane eclipses, it is preferrable that connections that have already been modified are not again modified later for the time slot at hand.

Next, a proof of feasibility of the above treatment of mutual eclipses of whichever type will be presented.

1.8: Let [i, j] be a connection blocked by Earth. Then, replacing the connections {[i, j], [i+Δ, j+Δ]} by either {[i+Δ, j], [j+Δ, i]}, if this modification reverses the direction of the data flow in a subset of arcs, or otherwise by {[j+Δ, j], [i+Δ, i]}, ensures a ring-network topology (see FIG. 16A and FIG. 16B), assuming all other connections are realizable.

The prior knowledge on the sequence of visited nodes is not used for proposition 1.8, but merely their existence, and therefore the method can be applied recursively as long as the existence of the connection [i+Δ, j+Δ] is unaltered. The existence of the connection [i+Δ, j+Δ] is guaranteed by the initial connectivity, and is preserved through the recursive application of the proposed method. The orientation of an arc may however be modified.

In the above, methods for establishing ISL among a constellation of satellites have been described. In addition, the present disclosure is understood to likewise relate to one or more satellites adapted to implement (their part of) these methods, so that interaction of the one or more satellites, possibly with additional satellites, implements the methods described in the present disclosure. The present disclosure is further understood to relate to a constellation of satellites implementing (or being adapted to implement) the methods described throughout the disclosure.

It should be noted that the method features described above correspond to respective apparatus, system and computer program features that may not be explicitly described, for reasons of conciseness, and vice versa. The disclosure of the present document is considered to extend also to such apparatus, system, and computer program features, and vice versa. For example, such apparatus or system may be adapted (e.g., via an appropriately configured processor) to perform any or each of the steps described above, and such computer program may be adapted to cause a processor to perform any or each of the steps described above. The present disclosure should further be construed to be related to a computer-readable medium storing such computer program.

It should further be noted that the description and drawings merely illustrate the principles of the proposed method and system. Those skilled in the art will be able to implement various arrangements that, although not explicitly described or shown herein, embody the principles of the disclosure and are included within its spirit and scope. Furthermore, all examples and embodiment outlined in the present document are principally intended expressly to be only for explanatory purposes to help the reader in understanding the principles of the proposed method and system. Furthermore, all statements herein providing principles, aspects, and embodiments of the disclosure, as well as specific examples thereof, are intended to encompass equivalents thereof.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

### ANNEX: CONNECTIVITY

### Notation

Number of satellites: N
Satellite index: 1≤i≤N, i∈ [symbol]
Satellite index: 1≤j≤N, j∈ [symbol]
x⊙N (for x≥0): remainder of x divided by N
x⊙N (for x<0): remainder of (k+kN) divided by N, with k∈ [symbol] large enough to ensure x+kN≥0

x⊕y:=(x+y)⊙N

### DEFINITION

Satellite pair: (i, j), with i≠j or i=j
Satellite set: S(t)={(iₖ, jₖ)}, with 1≤t≤N−1, such that it fulfils the following three conditions:

[U_{K}{iₖ}]∪[Uₖ{jₖ}]={1,2,3, . . . , N} Condition (I)

jₖ is such that (iₖ+jₖ)⊙N=t Condition (II)

(iₖ, jₖ)∈S(t)⇔(jₖ, iₖ)∈S(t) Condition (III)

Notably, Condition (II) does not invalidate Condition (I), because for any 1≤iₖ≤N there exists jₖ such that (iₖ+jₖ)⊙N=t.

### Proposition

Given an even number of satellites, set S(tₐ) and set S(t_{b}), with t_{b}=(tₐ+q)⊙N, q being a prime number not a divisor of N in [1, N), then S(tₐ)∪S(t_{b}) is connected and not a circuit.

### Proof:

(I): If tₐ⊙2=1 then necessarily t_{b}⊙2=0 and vice versa.

t_{b}=(tₐ+q)⊙N

t_{b}=(tₐ+q)⊙N

t_{b}=(tₐ+q)⊙N

t_{b}⊙2=(tₐ+q)⊙N)⊙2

t_{b}⊙2=(tₐ+q)⊙2 (because N is even)

t_{b}⊙2=(tₐ⊙2+q⊙2)⊙2

t_{b}⊙2=(1+1)⊙2=0 (because q is odd)
Corollary: if tₐ⊙2=0 then necessarily t_{b}⊙2=1, vice versa.

Hereafter is assumed that S(tₐ) is the set for which tₐ ⊙2=1 and S(t_{b}) is the set for which t_{b}⊙2=0.
(II): For pair (iₖ, jₖ)∈S(tₐ) form (I), jₖ≠iₖ.

Because (iₖ+jₖ)⊙N=tₐ, tₐ⊙2=1 and N is even, then iₖ≠jₖ, as otherwise (iₖ+iₖ)⊙N=tₐ

(2iₖ⊙N)⊙2=tₐ⊙2 (because N is even)

2iₖ⊙2=0=1 (which is a contradiction)

The value of jₖ is deduced hereafter. Because (iₖ+jₖ)⊙N=tₐ, 1≤iₖ≤N and 1≤jₖ≤N, we have

jₖ=N when iₖ=tₐ<N (due to of uniqueness of value jₖ satisfying (iₖ+jₖ)⊙N=tₐ odd)

iₖ=tₐ−iₖ when iₖ<tₐ<N (due to uniqueness of value jₖ satisfying (iₖ+jₖ)⊙N=tₐ odd)

jₖ=tₐ−iₖ+N when iₖ>tₐ (due to uniqueness of value jₖ satisfying (iₖ+jₖ)⊙N=tₐ odd)

Note: if jₖ satisfies (iₖ+jₖ)⊙N=tₐ and j*ₖ satisfies (iₖ+j*ₖ)⊙N=tₐ then (jₖ−j*ₖ)⊙N=0, which is not possible.
(III): For pair (i_{w}, j_{w})∈S(t_{b}) from (I), j_{w}≠i_{w} unless i_{w} ∈{t_{b}/2, N/2+t_{b}/2}

Because (i_{w}+j_{w})⊙N=t_{b}, t_{b}⊙2=0, and N is even:

(i_{w}+j_{w})⊙N=t_{b} (due to the assumption jₖ=iₖ)

2i_{w}⊙N=t_{b} (due to the assumption jₖ=iₖ)

⇔i_{w}∈{t_{b}/2,N/2+t_{b}/2} (because 1≤i_{w}≤N)
(IV): For any arbitrary satellite pair (iₖ, jₖ)∈S(tₐ) there exist (i_{w}, j_{w})∈S(t_{b}) such that i_{w}=jₖ, because of Condition (I) and Condition (II) in the definition of sets S(tₐ) and S(t_{b}).
(V): For pairs (iₖ, jₖ)∈S(tₐ) and (i_{w}, j_{w})∈S(t_{b}), from (IV), j_{w}=(iₖ+q)⊙N

Because i_{w}=jₖ and (i_{w}+j_{w})⊙N=t_{b}≠tₐ, then j_{w}≠iₖ

Because j_{w}≠iₖ and 1≤j_{w}≤N and 1≤iₖ≤N, then j_{w}=iₖ+δ, with δ∈{±1, ±2, . . . , ±(N−1)}

Thus:

(i_{w}+j_{w})⊙N=t_{b}

(j_{w}+iₖ+δ)⊙N=(tₐ+q)⊙N

[(jₖ+iₖ)⊙N+δ⊙N]⊙N=(tₐ+q)⊙N

(tₐ+δ)⊙N=(tₐ+q)⊙N

δ∈{+q−N,+q}

Because 1≤j_{w}=iₖ+δ≤N then when iₖ≤N−q necessarily δ=+q, and when iₖ>N−q, necessarily δ=+q−N.

Thus j_{w}=(iₖ+q)⊙N. Example: for valid (iₖ, jₖ)=(tₐ−t_{b}/2, t_{b}/2) and (i_{w}>j_{w})=(t_{b}/2, t_{b}/2), j_{w}−iₖ=t_{b}−tₐ=q.
(VI): Let q be a prime number in [1, N) that is not a divisor of N, and k≤N an arbitrary natural number.

Then:

∀y∈{0,1,2,3, . . . , (N−1)} there exists z_{y}∈{0,1,2,3, . . . , (N−1)} such that (k+yq)⊙(N=z_{y}, where z_{y}=z_{y}, only if y=y′.

z_{y}=k+y·q−m_{y}N, q>0, m_{y}>0, m_{y}∈

[symbol]

For y=0, z₀=k−m₀N and then necessarily z₀=k

The condition z_{y}=z_{y}, if y≠y′ then:

z_{y}=k+yq−m_{y}N

z_{y′}=k+y′q−m_{y′}N

z_{y}−z_{y′}=0=+(y−y′)q−(m_{y}−m_{y′})N

0=([y−y′]q)⊙N=([y′−y]q)⊙⊕N

Thus (y−y′) and (y′−y) are even, and one of them is in the interval [1, N) and thus ∈{2, 4, 6, . . . , N−2}.

Therefore q would satisfy (on the left without considering that q ∈[1, N), and on the right considering the same:

$$( \begin{matrix}2 q ∈ \{ 1 , 2 \} N \\ 4 q ∈ \{ 1 , 2 , 3 , 4 \} N \\ ⋮ \\ ( N - 2 ) q ∈ \{ 1 , 2 , 3 , … , ( N - 2 ) \} N\end{matrix} ) ( \begin{matrix}q ∈ \{ \frac{1}{2} , \frac{2}{2} \} N ⋂ [ 1 , N ) \\ q ∈ \{ \frac{1}{4} , \frac{2}{4} , \frac{3}{4} , \frac{4}{4} \} N ⋂ [ 1 , N ) \\ ⋮ \\ q ∈ \{ \frac{1}{[ N - 2 ]} , \frac{2}{[ N - 2 ]} , … , \frac{[ N - 2 ]}{[ N - 2 ]} \} N ⋂ [ 1 , N )\end{matrix} ) ( \begin{matrix}q ∈ \{ \frac{N}{2} \} \\ q ∈ \{ \frac{N}{4} , \frac{2 N}{4} , \frac{3 N}{4} \} \\ ⋮ \\ q ∈ \{ \frac{N}{[ N - 2 ]} , \frac{2 N}{[ N - 2 ]} , … , \frac{[ N - 3 ] N}{[ N - 2 ]} \}\end{matrix} )$$

This is in contradiction with q being a prime number in [1, N) that is not a divisor of N.
(VII): Let q be a prime number in [1, N) that is not a divisor of N. S(tₐ)∪S(t_{b}) is connected and is not a circuit.

Above sub-propositions (II), (III), (IV), and (V) guarantee that any satellite (with index (k+bq)⊙N) is connected to at least another satellite with index either (k+(b+1) q)⊙N or (k+(b−1)q)⊙N; and sub-proposition (VI) guarantees that these connections realize all indexes in [1, N], and therefore that all satellites are connected.

Moreover because

$$( \frac{{t}_{b}}{2} , \frac{{t}_{b}}{2} ) ∈ S ( {t}_{b} ) and ( \frac{N}{2} + \frac{{t}_{b}}{2} , \frac{N}{2} + \frac{{t}_{b}}{2} )$$

∈S(t_{b}), S(tₐ)∪S(t_{b}) is not a circuit.

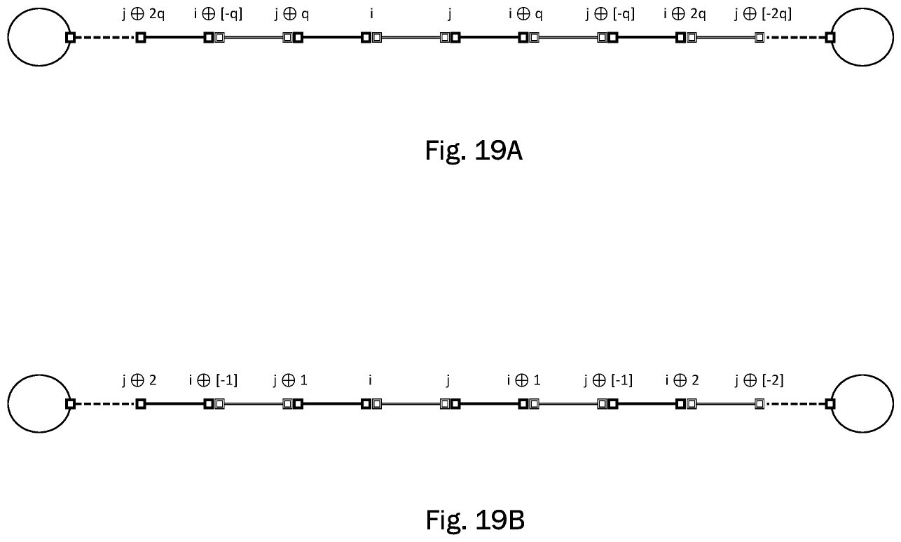

FIG. 19A shows the corresponding problem graph for q≠1.
(VIII): Let q=1. S(tₐ)∪S(t_{b}) is connected and is not a circuit.

Above sub-propositions (II), (III), (IV), and (V) guarantee that any satellite (with arbitrary index k*⊙N) is connected to at least another satellite with index either (k*+1)⊙N or (k*−1)⊙N; this guarantees that these connections realize all indexes in [1, N], and therefore that all satellites are connected.

FIG. 19B shows the corresponding problem graph for q=1.

### Corollary

Given an even number of satellites, set S(tₐ) and set S(t_{b}), with t_{b}=(tₐ+q) ⊕N and q being either 1 or a prime number that is not a divisor of N in [2, N), then S(tₐ)∪\tilde{S}(t_{b}) is a circuit, where \tilde{S}(t_{b}) is given by:

$$\{ S ( {t}_{b} ) - \{ ( \frac{{t}_{b}}{2} , \frac{{t}_{b}}{2} ) , ( \frac{N}{2} + \frac{{t}_{b}}{2} , \frac{N}{2} + \frac{{t}_{b}}{2} ) \} \} ⋃ \{ ( \frac{{t}_{b}}{2} , \frac{N}{2} + \frac{{t}_{b}}{2} ) , ( \frac{N}{2} + \frac{{t}_{b}}{2} , \frac{{t}_{b}}{2} ) \}$$

### EXAMPLE

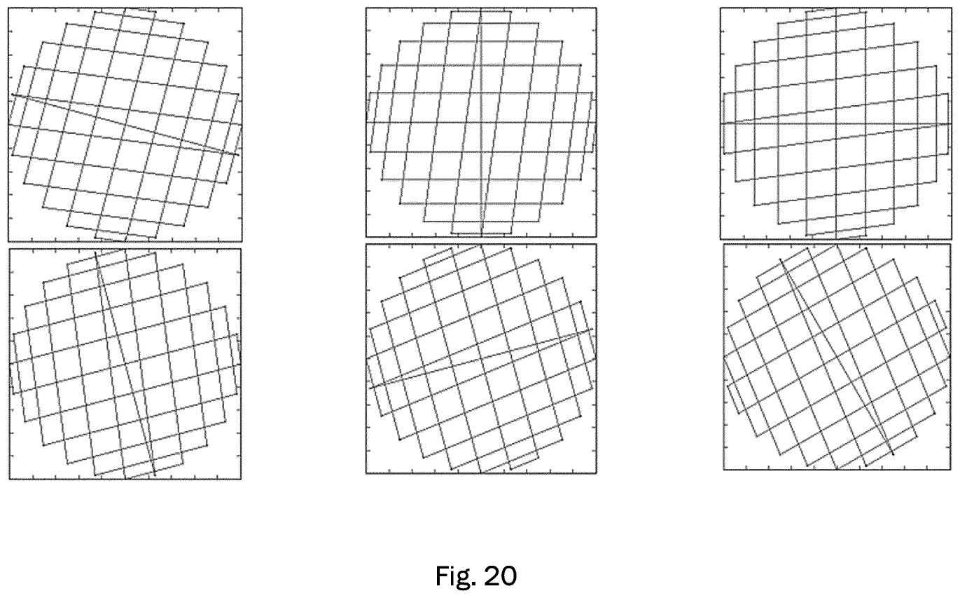

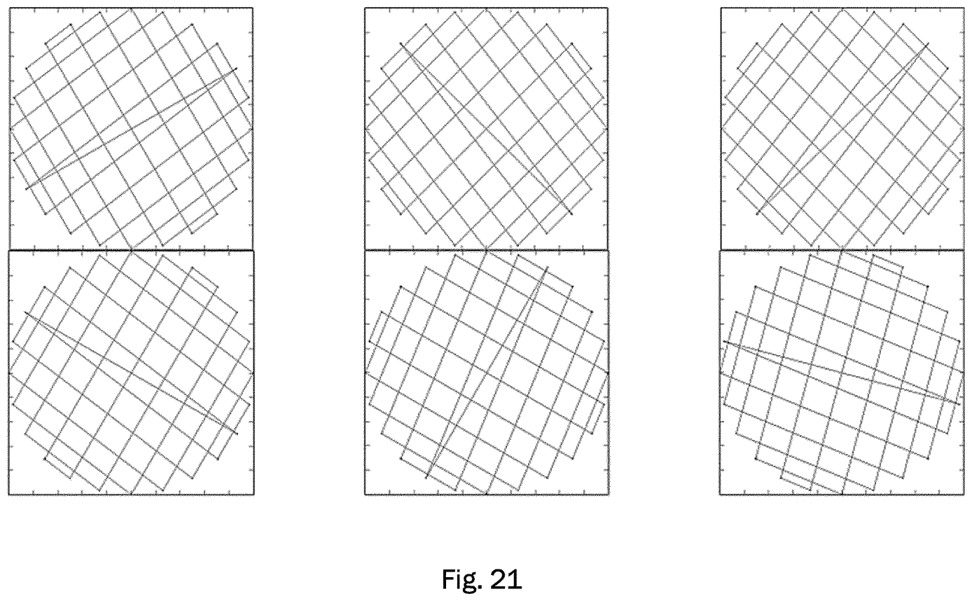

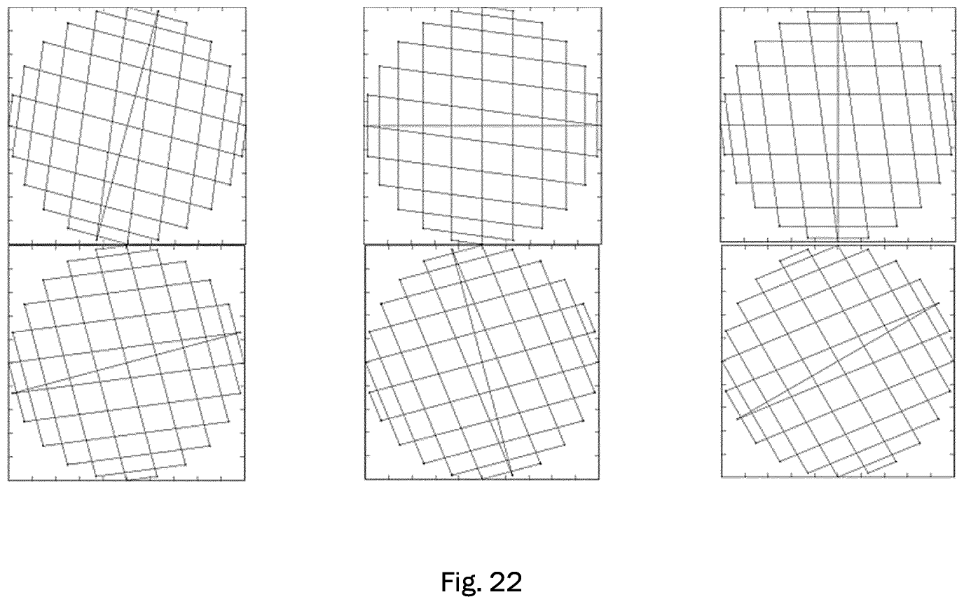

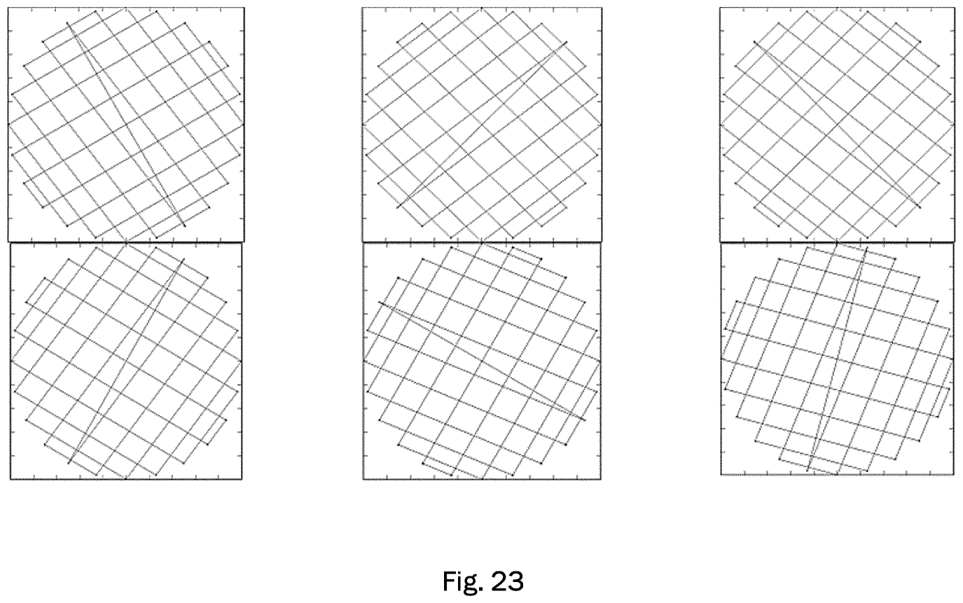

Ring functional topologies over time for a 24 satellites constellation operating ISL on two frequencies (F1 and F2). Each topology can be understood as the combination of two topologies, one based on F1 (and optimum for it, for example in line with the schemes described throughout the disclosure), and another one based on F2 (and optimum for it, for example in line with the schemes described throughout the disclosure). The example is optimum as well with regard to revisit time. The constellation is represented arbitrarily on a circumference (with radius equal to one) by 24 points equally spaced in FIG. 20, FIG. 21, FIG. 22, and FIG. 23.

Of these, FIG. 20 shows an example of ring configurations at TDMA time slots 1, 2, 3, 4, 5 and 6 (from top-left to bottom-right) for the 24 satellites example. FIG. 21 shows an example of ring configurations at TDMA time slots 7, 8, 9, 10, 11 and 12 (from top-left to bottom-right). FIG. 22 shows an example of ring configurations at TDMA time slots 13, 14, 15, 16, 17 and 18 (from top-left to bottom-right). Finally, FIG. 23 shows an example of ring configurations at TDMA time slots 19, 20, 21, 22 23 and 24 (from top-left to bottom-right).

1. A method of establishing inter-satellite links between satellites of a constellation of satellites, the satellites being arranged in a plurality of orbital planes in pairs of satellites orbiting Earth in substantially diametral orbit positions, the method comprising, for a given satellite among the constellation of satellites:
in a first period of time, establishing inter-satellite links between the given satellite and a first set of satellites including one or more pairs of satellites in a first orbital plane among the plurality of orbital planes;
in a second period of time, establishing inter-satellite links between the given satellite and a second set of satellites including one or more pairs of satellites in a second orbital plane among the plurality of orbital planes, different from the first orbital plane; and
in a third period of time, establishing inter-satellite links between the given satellite and a third set of satellites including one or more pairs of satellites in a third orbital plane among the plurality of orbital planes, different from the first and second orbital planes.

2. The method according to claim 1, wherein each of the first to third sets of satellites includes two pairs of satellites and wherein in each of the first to third sets of satellites, neighboring satellites, along orbit, are shifted from each other along orbit by 90° in argument of latitude angle.

3. The method according to claim 1, wherein the first to third sets of satellites include equal numbers of pairs of satellites.

4. The method according to claim 1, further comprising:
in a fourth period of time, establishing inter-satellite links between the given satellite and a fourth set of satellites including one or more pairs of satellites in the first orbital plane, wherein the first and fourth sets of satellites are disjoint sets;
in a fifth period of time, establishing inter-satellite links between the given satellite and a fifth set of satellites including one or more pairs of satellites in the second orbital plane, wherein the second and fifth sets of satellites are disjoint sets; and
in a sixth period of time, establishing inter-satellite links between the given satellite and a sixth set of satellites including one or more pairs of satellites in the third orbital plane, wherein the third and sixth sets of satellites are disjoint sets.

5. The method according to claim 4, wherein each of the fourth to sixth sets of satellites includes two pairs of satellites and wherein in each of the fourth to sixth sets of satellites, neighboring satellites, along orbit, are shifted from each other along orbit by 90° in argument of latitude angle.

6. The method according to claim 4, wherein the first to sixth sets of satellites include equal numbers of pairs of satellites.

7. The method according to claim 1, wherein the first to third periods of time are subdivided into sequential time slots of equal duration, in such manner that the first period of time includes a respective time slot for each of the satellites of the first set of satellites, the second period of time includes a respective time slot for each of the satellites of the second set of satellites, and the third period of time includes a respective time slot for each of the satellites of the third set of satellites, and the method comprises:
in the time slots of the first period of time, establishing inter-satellite links between the given satellite and respective satellites of the first set of satellites;
in the time slots of the second period of time, establishing inter-satellite links between the given satellite and respective satellites of the second set of satellites; and
in the time slots of the third period of time, establishing inter-satellite links between the given satellite and respective satellites of the third set of satellites.

8. The method according to claim 4, wherein the fourth to sixth periods of time are subdivided into sequential time slots of equal duration, in such manner that the fourth period of time includes a respective time slot for each of the satellites of the fourth set of satellites, the fifth period of time includes a respective time slot for each of the satellites of the fifth set of satellites, and the sixth period of time includes a respective time slot for each of the satellites of the fifth set of satellites, and the method comprises:
in the time slots of the fourth period of time, establishing inter-satellite links between the given satellite and respective satellites of the fourth set of satellites;
in the time slots of the fifth period of time, establishing inter-satellite links between the given satellite and respective satellites of the fifth set of satellites; and
in the time slots of the sixth period of time, establishing inter-satellite links between the given satellite and respective satellites of the sixth set of satellites.

9. The method according to claim 4, wherein assuming that the satellites of the constellation of satellites have consecutive numbers assigned thereto, ranging from 1 to N, starting with the satellites of the first set of satellites and followed, in this order, by the satellites of the second to sixth sets of satellites, where N is the number of satellites in the constellation of satellites, and wherein the method proceeds in cycles of N consecutive time slots each, the method comprising:
in an n-th time slot of the N time slots, establishing inter-satellite links between an s-th satellite and an (n-s)-th satellite, where s runs from 1 to N and wherein numbers of satellites are modulo N.

10. The method according to claim 9, wherein the inter-satellite links established in each time slot of the cycles use a first frequency or frequency band, and the method further comprises:
in the n-th time slot of a cycle of N time slots, establishing inter-satellite links between an (s)-th satellite and an (n−s+q)-th satellite using a second frequency or frequency band different from the first frequency or frequency band, where s runs from 1 to N, wherein q is a prime number in the range from 1 to N and not a divisor of N, and wherein numbers of satellites are modulo N, thereby establishing a ring topology of inter-satellite links between the satellites of the constellation of satellites.

11. The method according to claim 9, further comprising, for each time slot:
if a combination of an i-th satellite and a j-th satellite for which establishing an inter-satellite link is foreseen in the given time slot is under mutual eclipse, and if the i-th satellite and the j-th satellite are in the same orbital plane, instead of establishing an inter-satellite link between the i-th satellite and the j-th satellite, and further, instead of establishing an inter-satellite link between an (i+Δ)-th satellite and a (j+Δ)-th satellite, establishing an inter-satellite link between the (i+Δ)-th satellite and the i-th satellite, and between the (j+Δ)-th satellite and the j-th satellite, or establishing an inter-satellite link between the (i+Δ)-th satellite and the j-th satellite, and between the (j+Δ)-th satellite and the i-th satellite.

12. The method according to claim 9, further comprising, for each time slot:
if a combination of an i-th satellite and a j-th satellite for which establishing an inter-satellite link is foreseen in the given time slot is under mutual eclipse, and if the i-th satellite and the j-th satellite are not in the same orbital plane, instead of establishing an inter-satellite link between the i-th satellite and the j-th satellite, and further, instead of establishing an inter-satellite link between an (i+Δ)-th satellite and a (j+Δ)-th satellite, establishing an inter-satellite link between the (i+Δ)-th satellite and the i-th satellite, and between the (j+Δ)-th satellite and the j-th satellite, or establishing an inter-satellite link between the (i+Δ)-th satellite and the j-th satellite, and between the (j+Δ)-th satellite and the i-th satellite.

13. The method according to claim 1, further comprising:
determining ranging information relating to relative distances between the given satellite and respective other satellites of the constellation of satellites based on the established inter-satellite links; and
determining an estimate of a position of the given satellite relative to the other satellites of the constellation of satellites based on the determined ranging information.

14. The method according to claim 1, wherein the satellites of the constellation of satellites are arranged in three orbital planes; and/or
wherein the orbital planes are substantially orthogonal to each other.

15. A constellation of satellites implementing the method according to claim 1.
